(19) United States
(12) Patent Application Publication
(10) Pub. No.: US 2026/0051694 A1
(43) Pub. Date: Feb. 19, 2026

(54) CONNECTOR

(71) Applicant: SUMITOMO WIRING SYSTEMS, LTD., Mie (JP)

(72) Inventor: Atsuya IKEDA, Mie (JP)

(21) Appl. No.: 19/102,415

(22) PCT Filed: Jul. 26, 2023
(86) PCT No.: PCT/JP2023/027341

§ 371 Date: Feb. 10, 2025

(30) Foreign Application Priority Data
Aug. 16, 2022 (JP) 2022-129629

(51) Int. Cl. H01R 13/52; H01R 12/72

(52) U.S. Cl. CPC H01R 13/5227; H01R 12/722

(57) ABSTRACT

A connector includes a first housing and a second housing, which are fittable to each other. The first housing has a fitting section in which the second housing is accommodated, the fitting section being open forward in a fitting direction in which the first housing is fitted to the second housing. Of walls of the first housing that demarcate the fitting section, a first wall located on a lower side has, in a wall surface facing an interior of the fitting section, an inclined section that is inclined downward while extending forward and forms a gap (water discharge path) with the second housing accommodated in the fitting section. A second wall intersecting and adjacent to the first wall is positioned so as to shield the circuit board and the inclined section from each other on a side facing a board surface of the circuit.

### TECHNICAL FIELD

The present disclosure relates to a connector.

### BACKGROUND

Patent Document 1 discloses a waterproof connector having first and second connectors that are fittable to each other. The first connector has an opening-expanding tapered surface in an inner wall of a tubular case. A connection terminal is attached to a back wall of the first connector. The connection terminal is connected to a circuit board that is located on the back side of the first connector. The second connector accommodates a contactor connectable to the connection terminal. The contactor is connected to a control cable. A waterproofing member is attached to the outer periphery of the control cable.

When the first and second connectors are in a fitted state, the outer periphery of the waterproofing member is in intimate contact with the opening-expanding tapered surface, thereby making it possible to waterproof the interior of the case. Patent Documents 2 to 4 also disclose connectors each of which has an inclined surface portion similar to the opening-expanding tapered surface and is connected to a circuit board.

### PRIOR ART DOCUMENT

### Patent Document

Patent Document 1: JP H07-226257 A

Patent Document 2: JP H09-134756 A

Patent Document 3: JP 2017-174577 A

Patent Document 4: JP 2019-153546 A

### SUMMARY OF THE INVENTION

### Problems to be Solved

In Patent Document 1, even if water enters inside the case when the first and second connectors are in a fitted state, the presence of the waterproofing member prevents the water from being discharged from the opening side of the case. There is therefore a concern that water would flow from inside the case toward the circuit board through an insertion hole for the connection terminal (a hole formed at the portion indicated by reference sign 11b in FIG. 4 of Patent Document 1) or the like.

The present disclosure aims to prevent water entering inside the connector from flowing toward the circuit board.

### Means to Solve the Problem

A connector of the present disclosure includes: a first housing; and a second housing fittable to the first housing, wherein the first housing has a fitting section in which the second housing is accommodated, the fitting section being open forward in a fitting direction in which the first housing is fitted to the second housing, of walls of the first housing that demarcate the fitting section, a first wall located on a lower side has, in a wall surface facing an interior of the fitting section, an inclined section that is inclined downward while extending forward and forms a gap with the second housing accommodated in the fitting section, and a second wall intersecting and adjacent to the first wall is positioned so as to shield the circuit board and the inclined section from each other on a side facing a board surface of the circuit board.

### Effect of the Invention

According to the present disclosure, it is possible to provide a connector capable of preventing water from flowing toward the circuit board.

### BRIEF DESCRIPTION OF THE DRAWINGS

FIG. 1 is a perspective view of a connector according to Embodiment 1 of the present disclosure in a state where a first housing and a second housing fitted to each other.

FIG. 2 is a front view of a portion including an upper fitting section in the state of FIG. 1.

FIG. 3 is a cross-sectional view of a portion including the upper fitting section in the state of FIG. 1.

FIG. 4 is an enlarged cross-sectional view of a portion with a gap shown in FIG. 3.

FIG. 5 is a perspective view of the second housing as seen from the rear.

FIG. 6 is a front view of the first housing with a first terminal fitting attached.

FIG. 7 is a perspective view of the first housing with the first terminal fitting attached as seen from a second wall side.

FIG. 8 is an enlarged perspective view of a portion with an inclined section and other sections shown in FIG. 7.

### DETAILED DESCRIPTION TO EXECUTE THE INVENTION

### Description of Embodiments of the Present Disclosure

Firstly, modes for carrying out the present disclosure are listed and described.
(1) A connector of the present disclosure is a connector including: a first housing; and a second housing fittable to the first housing, wherein the first housing has a fitting section in which the second housing is accommodated, the fitting section being open forward in a fitting direction in which the first housing is fitted to the second housing, of walls of the first housing that demarcate the fitting section, a first wall located on a lower side has, in a wall surface facing an interior of the fitting section, an inclined section that is inclined downward while extending forward and forms a gap with the second housing accommodated in the fitting section, and a second wall intersecting and adjacent to the first wall is positioned so as to shield the circuit board and the inclined section from each other on a side facing a board surface of the circuit board.

With this configuration, even if water enters inside the fitting section when the first and second housings are in a fitted state, the water can be discharged from the front end of the first wall through the inclined section. In particular, a water discharge path can be secured by the gap formed between the inclined section and the second housing.

Further, the space between the inclined section and the circuit board is shielded (blocked) by the second wall, thereby making it possible to prevent water from flowing from the inclined section toward the circuit board.
(2) It is preferable that the inclined section extends from a rear end side to a front end side of the wall surface of the first wall with respect to the fitting direction.

With this configuration, even if water enters deep inside the fitting section, the water can be discharged from the rear end of the inclined section through the front end thereof.
(3) It is preferable that the inclined section is formed at a portion of the wall surface of the first wall, and the first wall has, at another portion of the wall surface, a creeping section extending along the second housing accommodated in the fitting section.

In the present disclosure, a gap is formed between the first wall of the first housing and the second housing, while with this configuration, the creeping section of the first wall extends along the second housing, so that the second housing can be fitted inside the fitting section without rattling.
(4) It is favorable that the front end side of the inclined section has a smaller width in a left-right direction than the rear end side of the inclined section.

This configuration can achieve a structure in which water is unlikely to enter the gap from the front end side of the inclined section.
(5) It is preferable that the inclined section is located in the wall surface of the first wall with an interval in the left-right direction, the creeping section is located between two inclined sections adjacent to each other in the left-right direction, each of which is the inclined section, and the first wall has, in the wall surface, a second inclined section inclined downward in the left-right direction from the creeping section to the inclined section.

With this configuration, water present on the creeping section side can be discharged from the second inclined section through the inclined section.
(6) It is preferable that the second wall extends vertically along an up-down direction serving as a board surface direction of the circuit board, and has a larger dimension in the up-down direction than a dimension in a left-right direction of the first wall.

This configuration can achieve a structure in which water is unlikely to accumulate on the board surface of the circuit board. Furthermore, the dimension in the up-down direction of the second wall is greater than the dimension in the left-right direction of the first wall, thereby making it possible to enhance the shielding effect of the second wall.

### DETAILS OF EMBODIMENTS OF PRESENT DISCLOSURE

Specific examples of the present disclosure are described below with reference to the drawings. Note that the present invention is not limited to these examples but is defined by the claims, and is intended to include all changes made within the meaning and scope equivalent to the claims.

### Embodiment 1

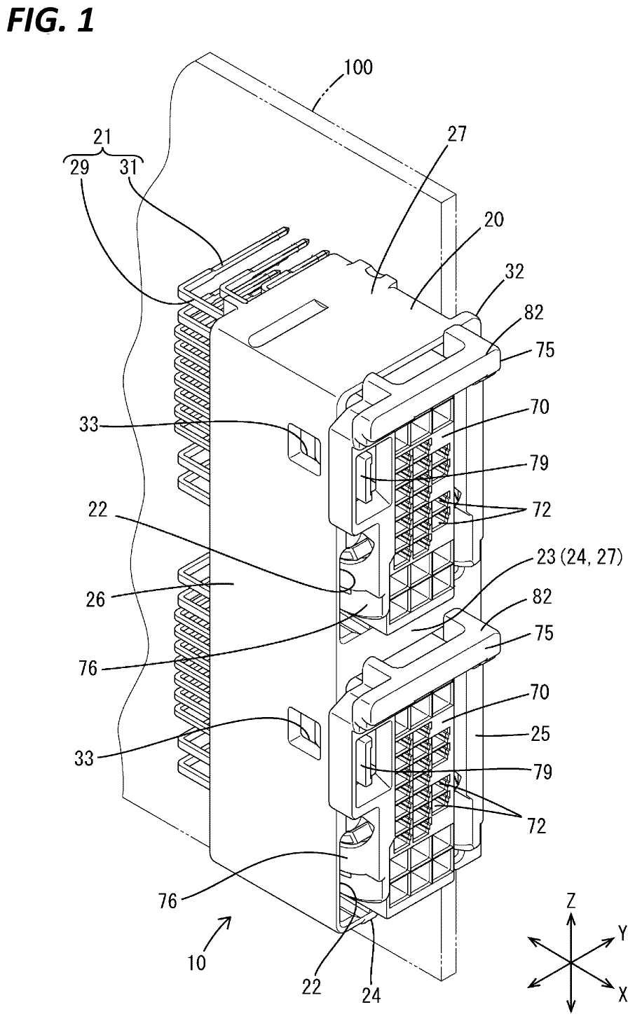

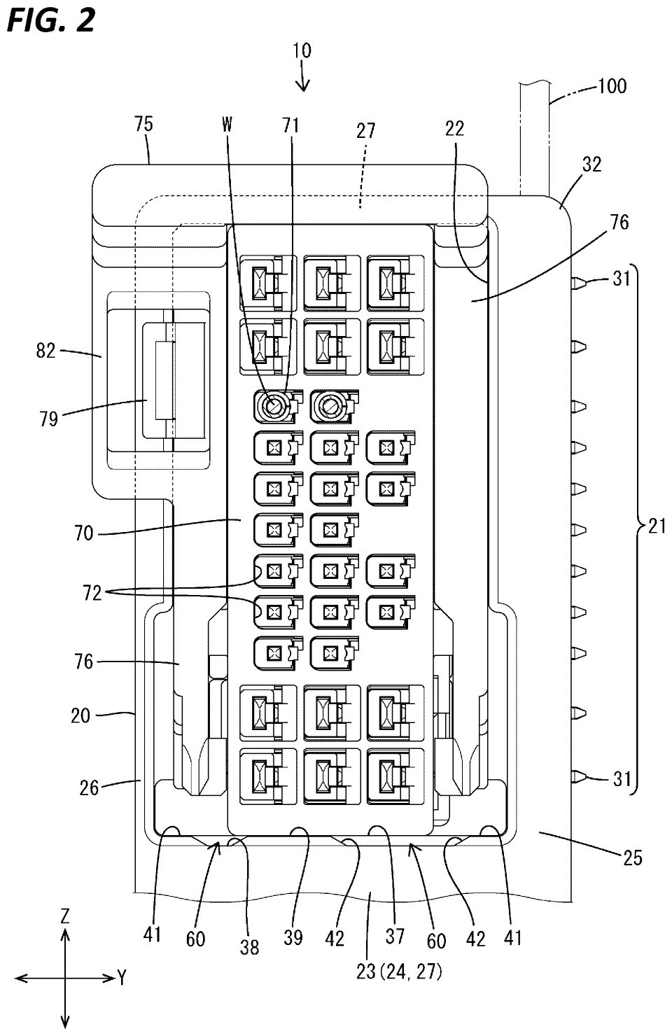

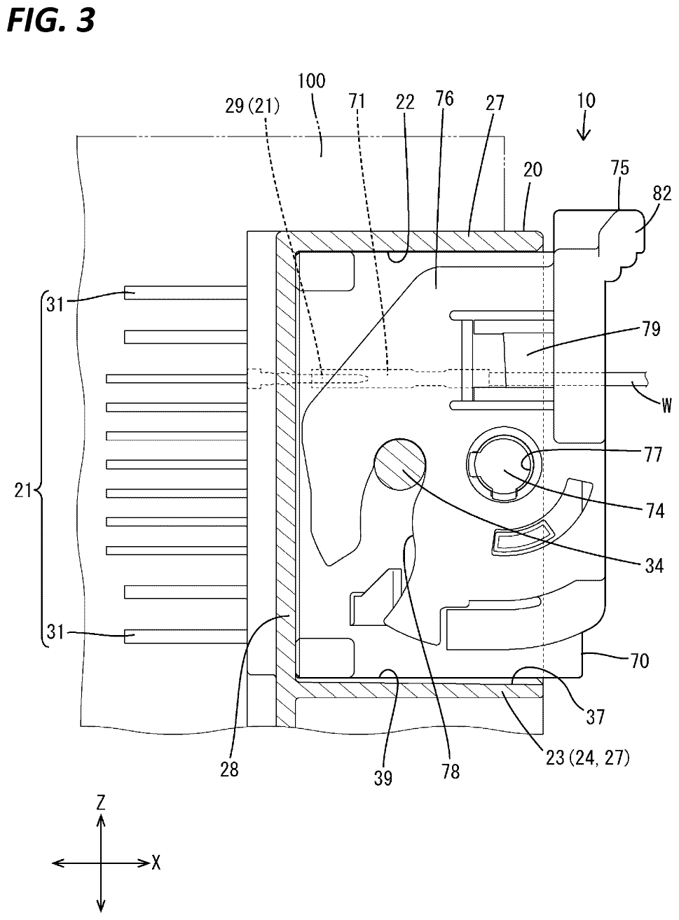

As shown in FIG. 1, a connector 10 according to Embodiment 1 of the present disclosure includes a first housing 20 and a second housing 70, which are fittable to each other. As shown in FIGS. 2 and 3, the connector 10 also includes first terminal fittings 21 and second terminal fittings 71, which are attached to the first housing 20 and the second housing 70, respectively, and a lever 75 fitted to the second housing 70. The first terminal fittings 21 are connected to a circuit board 100. Note that in the following description, the term “front-back direction” refers to the direction in which the front side is defined as the opposing-face side of the first housing 20 and the second housing 70 when fitted to each other. The left-right direction is based on the left-right direction in FIG. 2. The up-down direction is based on the up-down direction in each figure. In Embodiment 1, the up-down direction coincides with the up-down direction in a state where the connector 10 is installed in a vehicle or the like, and includes a case where the connector 10 is tilted with respect to the vertical direction. In the drawings, the signs “X”, “Y” and “Z” represent the front-back direction, the left-right direction, and the up-down direction, respectively.

### Second Housing, Lever, and Second Terminal Fitting

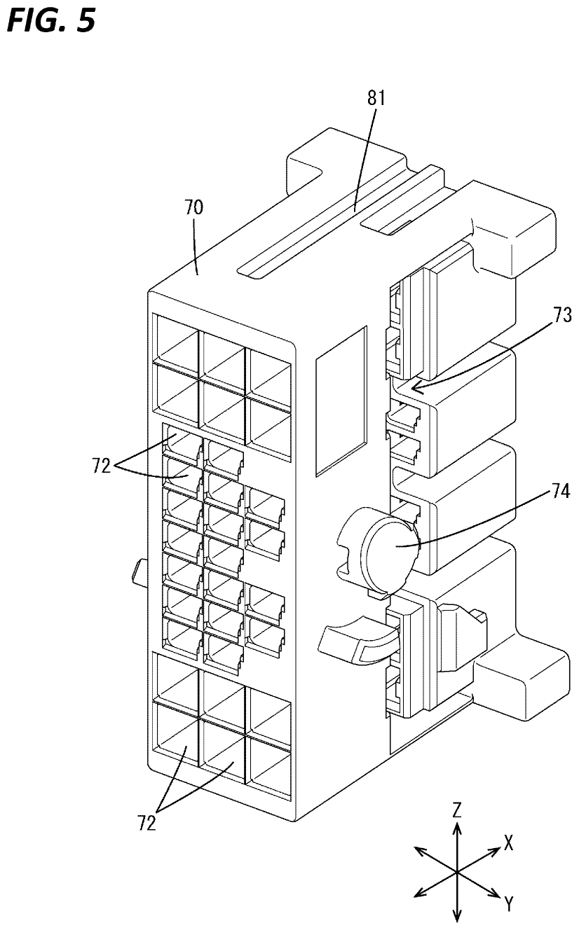

The second housing 70 is made of synthetic resin and has an overall rectangular block shape elongated in the up-down direction, as shown in FIG. 5. The second housing 70 has a plurality of cavities 72 extending therethrough in the front-back direction. The second terminal fittings 71 are inserted into respective cavities 72 from the rear of the second housing 70. Each second terminal fitting 71 is integrally formed by, for example, bending a conductive metal plate. Although not shown in detail, each second terminal fitting 71 is a female terminal fitting and is connected to an end of an electric wire W, as shown in FIG. 3. The wire W is pulled out rearward of the second housing 70 from the cavity 72.

As shown in FIG. 5, a retainer mounting hole 73 is formed in an open manner in a surface on a first side in the left-right direction of the second housing 70 (right surface in FIG. 5). A retainer (not shown) is mounted into the retainer mounting hole 73. The retainer locks the second terminal fittings 71 located inside the cavities 72 in a non-removable state.

A support shaft 74 having a circular column shape is formed in a protruding manner, rearward of the retainer mounting hole 73 in the surface on the first side in the left-right direction of the second housing 70. The support shaft 74 is also formed in a surface (not shown) on a second side in the left-right direction (the surface on the side opposite to the surface on the first side in the left-right direction) of the second housing 70. The lever 75 is rotatably supported by each of the support shafts 74.

The lever 75 is made of synthetic resin, has a gate-like frame shape as shown in FIG. 2, and has a pair of cam plates 76 facing each other. As shown in FIG. 3, each cam plate 76 has a bearing hole 77 for receiving a corresponding support shaft 74, and a cam groove 78 extending while curving. Of the cam plates 76, the cam plate 76 on the second side in the left-right direction has an elastically deformable lock arm 79.

When the first housing 20 and the second housing 70 begin to be fitted, a later-described cam pin 34 of the first housing 20 is inserted into an entry of the cam groove 78. When the lever 75 is rotated about the support shafts 74, the cam pin 34 moves along the groove surface of the cam groove 78, and the fitting of the first housing 20 and the second housing 70 progresses. When the first housing 20 and the second housing 70 are properly fitted, the lock arm 79 locks a later-described lock receiver 33 (see FIG. 1) of the first housing 20, thus holding the first housing 20 and the second housing 70 in the fitted state.

The upper and lower surfaces of the second housing 70 each have a fitting groove 81 (only the upper fitting groove 81 is shown in FIG. 5) that extends in the front-back direction and is open to the front end of the second housing 70. The fitting grooves 81 are formed at different positions in the left-right direction on the upper and lower surfaces of the second housing 70 so as to correspond to respective fitting ribs 36, which will be described later.

First Housing and First Terminal Fitting

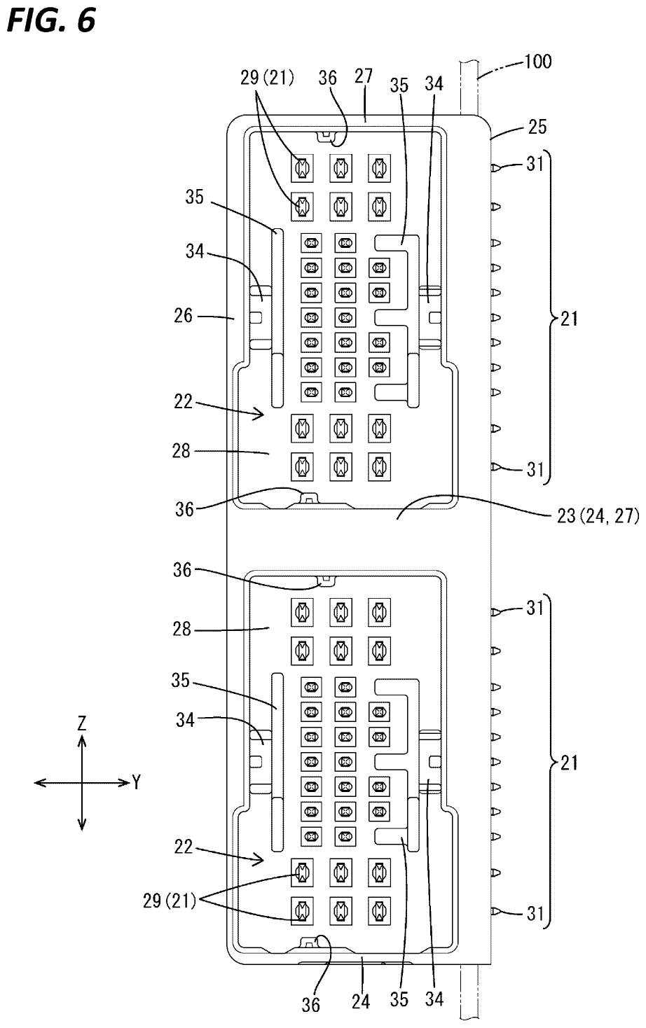

The first housing 20 is made of synthetic resin and has an overall rectangular box shape elongated in the up-down direction, as shown in FIG. 6. The first housing 20 has two fitting sections 22 on the upper and lower sides that are open forward. A division wall 23 separating the fitting sections 22 from each other is formed at the center in the up-down direction of the first housing 20. Two second housings 70 are provided in correspondence with the fitting sections 22, and are inserted into the respective fitting sections 22 from the front of the first housing 20 together with their levers 75. Note that the upper and lower fitting sections 22 have the same shape, and only one of the fitting section 22 will be described below unless otherwise necessary.

When viewed from the front, the fitting section 22 is demarcated by a first wall 24 located on the lower side of the interior of the fitting section 22, a second wall 25 located on the first side in the left-right direction (right side in FIG. 6), a third wall 26 located on the second side in the left-right direction (left side in FIG. 6), a fourth wall 27 located on the upper side of the interior of the fitting section 22, and a fifth wall 28 closing the distal (rear) end surface. The first wall 24 and the fourth wall 27 face each other in the up-down direction and extend along the left-right direction. The second wall 25 and the third wall 26 face each other in the left-right direction and extend along the up-down direction. The first wall 24 and the second wall 25 intersect and are adjacent to each other. The division wall 23 is the first wall 24 of the upper fitting section 22 and also the fourth wall 27 of the lower fitting section 22.

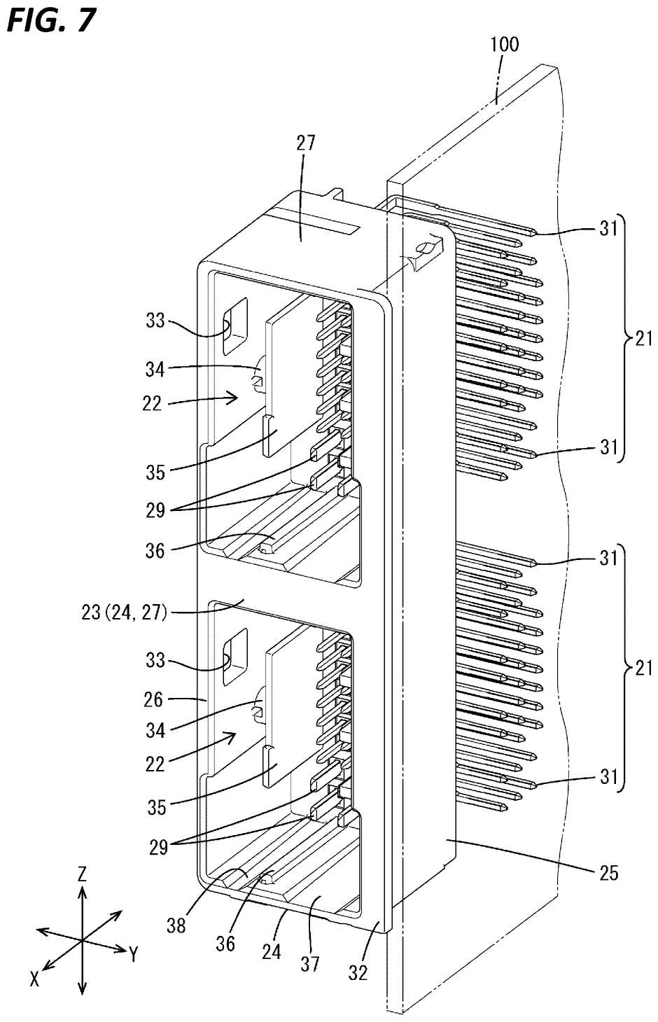

A plurality of first terminal fittings 21 are attached to the fifth wall 28 while extend therethrough. Each first terminal fitting 21 is made of conductive metal and has an overall L-shape, as shown in FIG. 1. Each first terminal fitting 21 has a terminal connecting section 29 extending in the front-back direction, and a board connecting section 31 extending in the left-right direction. As shown in FIG. 7, a front portion of the terminal connecting section 29 protrudes into the fitting section 22. When the first housing 20 and the second housing 70 are fitted, the front portion of the terminal connecting section 29 fits into and is connected to a corresponding second terminal fitting 71. A rear portion of the terminal connecting section 29 is exposed rearward of the first housing 20. The board connecting section 31 is shaped to extend from the rear end of the terminal connecting section 29 to the first side in the left-right direction where the second wall 25 is located, on the rear side of the first housing 20. An end on the first side in the left-right direction of the board connecting section 31 is connected to the circuit board 100.

The circuit board 100 is a rigid printed wiring board, and is positioned with its board surface aligned with the up-down direction. The board surface of the circuit board 100 faces the outer surface of the second wall 25 and is parallel therewith. As shown in FIG. 7, a flange 32 that defines the front end position of the circuit board 100 is formed in a protruding manner on the outer surface of the second wall 25. The flange 32 has a rib shape extending in the up-down direction at the front end of the second wall 25. A front portion of the circuit board 100 is located rearward of the flange 32, extending along the outer surface of second wall 25.

As shown in FIG. 7, the second wall 25 is a blocking wall that shields (blocks) the interior of each fitting section 22 from the circuit board 100, and has no holes or openings. The lock receivers 33 extend through the third wall 26 in correspondence with the respective fitting sections 22. Each lock receiver 33 is open in a rectangular shape in the inner and outer surfaces of the third wall 26.

As shown in FIG. 6, the second wall 25 and the third wall 26 each have two cam pins 34 protruding at positions facing each other at the center in the up-down direction of the fitting section 22. Each cam pin 34 has a circular column shape and can be inserted into the cam groove 78 of the lever 75, as shown in FIG. 3. As shown in FIG. 6, the fifth wall 28 has a pair of left and right partition walls 35 protruding into the interior of the fitting section 22. Each partition wall 35 is parallel with the second wall 25 and the third wall 26 at a position closer to the center in the left-right direction than the corresponding cam pin 34, with its plate surfaces oriented in the left-right direction. The partition walls 35 serve to prevent the first housing 20 and the second housing 70 from being fitted to each other in a twisted manner and to protect the terminal connecting section 29 of each first terminal fitting 21.

A fitting rib 36 is formed on each of the inner surfaces of the first wall 24 and the fourth wall 27, extending in the front-back direction and having a rear end joined to the fifth wall 28. As shown in FIG. 6, the fitting ribs 36 are formed at different positions in the left-right direction on the inner surfaces of the first wall 24 and the fourth wall 27. When the first housing 20 is inserted into the interior of the fitting sections 22 in a normal orientation, the fitting ribs 36 are fitted into the respective fitting grooves 81, and the fitting operation of the first housing 20 and the second housing 70 progresses. In contrast, if it is attempted to insert the first housing 20 in a vertically inverted orientation into the fitting section 22, the fitting ribs 36 will interfere with the first housing 20, thus restricting the fitting operation between the first housing 20 and the second housing 70.

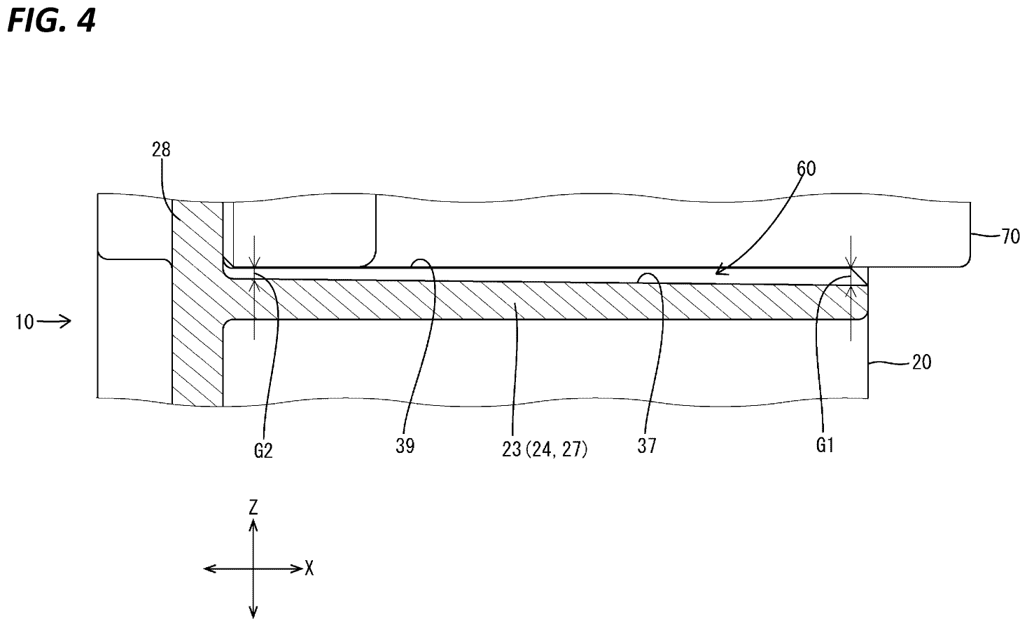

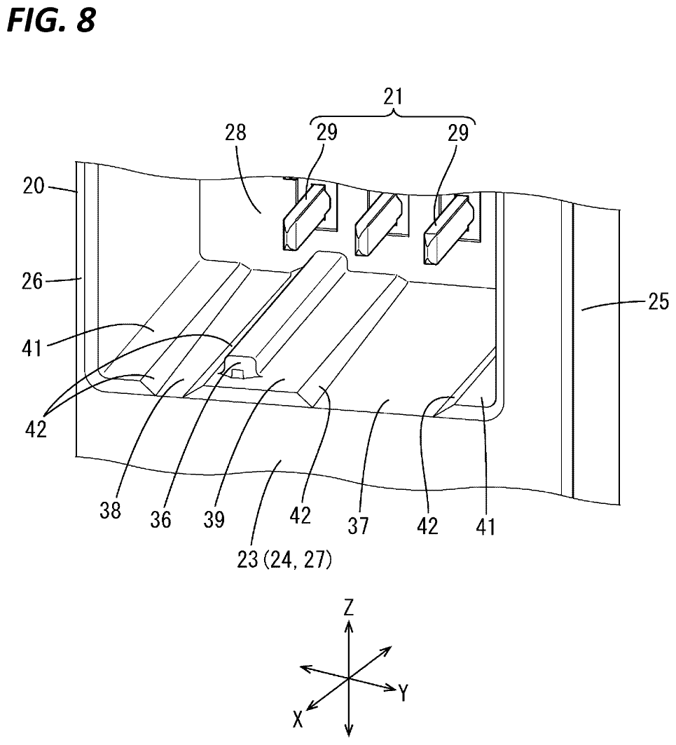

As shown in FIG. 8, the first wall 24 has a plurality of inclined sections 37 and 38, which are inclined downward while extending forward, in the inner surface (wall surface) facing the inside of the fitting section 22. The inclined sections 37 and 38 are formed over the entire length in the front-back direction of the inner surface of the first wall 24 (see FIG. 4). The rear ends of the inclined sections 37 and 38 intersect the fifth wall 28 at the distal end of the fitting section 22, and the front ends of the inclined sections 37 and 38 are located at the opening end of the fitting section 22. The inclined sections 37 and 38 are inclined at a constant angle from the rear end to the front end of the first wall 24. As shown in FIG. 8, each of the inclined sections 37 and 38 has a dimension in the left-right direction (hereinafter referred to as a “width dimension”) that gradually decreases from the rear end to the front end.

In Embodiment 1, the inclined sections 37 and 38 include a first-side inclined section 37 located on the first side (right side in FIG. 8) in the left-right direction in the inner surface of the first wall 24, and a second-side inclined section 38 located on the second side (left side in FIG. 8) in the left-right direction. The first-side inclined section 37 has an overall width dimension larger than the width dimension of the second-side inclined section 38.

As shown in FIG. 8, the first wall 24 also has creeping sections 39 and 41 that flatly extend in the front-back and left-right directions between the first-side inclined section 37 and the second-side inclined section 38, between the first-side inclined section 37 and the second wall 25, and between the second-side inclined section 38 and the third wall 26, in the inner surface of the first wall 24. The creeping section 39 on the central side between the first-side inclined section 37 and the second-side inclined section 38 has the fitting rib 36 protruding therefrom. The creeping section 39 on the central side has a width dimension larger than the width dimension of the creeping section 41 on each end side. Contrary to the inclined sections 37 and 38, the creeping sections 39 and 41 each have a width dimension that gradually decreases from the rear end to the front end.

Further, the first wall 24 has a plurality of second inclined sections 42 that are inclined downward from the creeping sections 39 and 41 toward the inclined sections 37 and 38 in the left-right direction between the creeping sections 39 and 41 and the inclined sections 37 and 38 that are adjacent in the left-right direction. The second inclined sections 42 are formed on both sides in the left-right directions of the first-side inclined section 37 and the second-side inclined section 38.

### Effects of Connector

The second housing 70 is fitted into the interior of the fitting section 22 of the first housing 20 by rotating the aforementioned lever 75. When the lock arm 79 is locked to the lock receiver 33, and the first housing 20 and the second housing 70 are properly fitted to each other, the cam plates 76 of the lever 75 are accommodated between the partition wall 35 on the first side in the left-right direction and the second wall 25 and between the partition wall 35 on the second side in the left-right direction and the third wall 26, respectively, except for a release operation section 82 (see FIG. 1) on the rear end side (details not shown).

As shown in FIG. 2, the upper surface of the second housing 70 is positioned along the inner surface of the fourth wall 27, and upper portions of the plate surfaces of the cam plates 76 are positioned along upper portions of the inner faces of the second wall 25 and the third wall 26. A lower portion of the plate surface of each cam plate 76 and a lower portion of the inner surface of each of the second wall 25 and the third wall 26 face each other with a larger gap (clearance) than a gap between their upper portions.

A portion of the lower surface of the second housing 70 on the second side in the left-right direction is positioned along the creeping section 39 on the central side. An end of the lower surface of the second housing 70 on the second side in the left-right direction faces the second-side inclined section 38 with a gap therebetween. A portion of the lower surface of the second housing 70 on the first side in the left-right direction faces the first-side inclined section 37 with a gap therebetween.

As shown in FIG. 4, the gap formed between the lower surface of the second housing 70 and each of the inclined sections 37 and 38 (the inclined section 37 in FIG. 4) has a height G1 on the front end side larger than a height G2 on the rear end side, and is configured as a water discharge path 60 that gradually increases its gap from the height G2 to the height G1.

When the connector 10 is in a state installed in a vehicle or the like, water may enter inside the connector 10 and travel between the inner surface of the fitting section 22 of the first housing 20 and the outer surface of the second housing 70, reaching the inner surface of the first wall 24. In Embodiment 1, water that has entered inside the connector can fall through the water discharge path 60 along the inclined sections 37 and 38 and be discharged downward from the front end of the first wall 24. Further, water can also fall from the creeping sections 39 and 41 side along the second inclined sections 42 and be then discharged from the front end of first wall 24 through the inclined sections 37 and 38. This can prevent water from accumulating inside the fitting section 22. In addition, water falls directly downward from the front end of the first wall 24, thereby making it possible to highly reliably avoid contact between water and the circuit board 100, which is positioned with its board surface facing the second wall 25 adjacent to the first side in the left-right direction of the first wall 24.

According to Embodiment 1, water that has entered inside the connector 10 can be prevented from flowing toward the circuit board 100, as described above. In particular, Embodiment 1, in which the connector 10 does not have a waterproofing member such as a rubber plug, can provide a simplified waterproof connector 10 that allows for a reduction in the number of parts, a simplified configuration, and avoidance of an increase in size.

In Embodiment 1, the inclined sections 37 and 38 are formed in the inner surface of the first wall 24 over the entire length in the front-back direction. Even if water enters deep inside the fitting section 22, the water can be discharged from the rear ends through the front ends of the inclined sections 37 and 38.

Furthermore, although a gap is formed between the inner surface of the first wall 24 of the first housing 20 and the outer surface of the second housing 70, the outer surface of the second housing 70 is positioned along the creeping section 39 of the first wall 24, allowing the second housing 70 to be fitted to the interior of the fitting section 22 without rattling.

In Embodiment 1, the width dimension on the front end side of each of the inclined sections 37 and 38 is smaller than the width dimension thereof on the rear end side, thereby allowing for a structure in which water is less likely to enter the gap from the front end side of the inclined sections 37 and 38.

Furthermore, the creeping section 39 on the central side is located between the first-side inclined section 37 and the second-side inclined section 38, which are adjacent in the left-right direction, and the second inclined sections 42, which are inclined downward in the left-right direction from the creeping section 39 toward the first-side inclined section 37 and the second-side inclined section 38, are formed in the inner surface of the first wall 24. This allows water present on the creeping section 39 side to be discharged from the second inclined sections 42 through the inclined sections 37 and 38.

In Embodiment 1, the circuit board 100 itself is positioned in a vertical orientation with its board surface aligned with the up-down direction, allowing for a structure in which water is unlikely to accumulate on the board surface of the circuit board 100. Furthermore, the dimension in the up-down direction of the second wall 25 is greater than the dimension in the left-right direction of the first wall 24, thereby making it possible to improve the shielding effect of the second wall 25.

### Other Embodiments of Present Disclosure

The above-described Embodiment 1 disclosed herein is illustrative in all respects and should not be considered restrictive.

In Embodiment 1, a plurality of inclined sections are formed in the inner surface of the first wall. In contrast, according to another embodiment, only one inclined section may be formed in the inner surface of the first wall. Alternatively, three or more inclined sections may be formed with intervals therebetween in the left-right direction in the inner surface of the first wall. Further, the inclined sections may be formed at both the left and right ends of the inner surface of the first wall, or one inclined section may be formed on the central side in the left-right direction.

In Embodiment 1, the second wall is formed as a portion shielding the inclined sections and the circuit board from each other. In contrast, according to another embodiment, the second wall need only be a wall of the fitting section that intersects and is adjacent to the first wall and shielding the inclined sections and the circuit board from each other. If the third wall or fifth wall in Embodiment 1 is a blocking wall located on the side opposing the board surface of the circuit board, such a third wall or fifth wall can also serve as the second wall of the present disclosure.

### LIST OF REFERENCE NUMERALS

10 Connector
20 First housing
21 First terminal fitting
22 Fitting section
23 Division wall
24 First wall
25 Second wall
26 Third wall
27 Fourth wall
28 Fifth wall
29 Terminal connecting section
31 Board connecting section
32 Flange
33 Lock receiver
34 Cam pin
35 Partition wall
36 Fitting rib
37 First-side inclined section (inclined section)
38 Second-side inclined section (inclined section)
39 Creeping section (on central side)
41 Creeping section (on end side)
42 Second inclined section
60 Water discharge path (gap)
70 Second housing
71 Second terminal fitting
72 Cavity
73 Retainer mounting hole
74 Support shaft
75 Lever
76 Cam plate
77 Bearing hole
78 Cam groove
79 Lock arm
81 Fitting groove
82 Release operation section
100 Circuit board
G1 Height on front end side
G2 Height on rear end side
W Wire

1. A connector comprising:
a first housing; and
a second housing fittable to the first housing,
wherein the first housing has a fitting section in which the second housing is accommodated, the fitting section being open forward in a fitting direction in which the first housing is fitted to the second housing,
of walls of the first housing that demarcate the fitting section, a first wall located on a lower side has, in a wall surface facing an interior of the fitting section, an inclined section that is inclined downward while extending forward and forms a gap with the second housing accommodated in the fitting section, and
a second wall intersecting and adjacent to the first wall is positioned so as to shield the circuit board and the inclined section from each other on a side facing a board surface of the circuit board.

2. The connector according to claim 1,
wherein the inclined section extends from a rear end side to a front end side of the wall surface of the first wall with respect to the fitting direction.

3. The connector according to claim 2,
wherein the inclined section is formed at a portion of the wall surface of the first wall, and
the first wall has, at another portion of the wall surface, a creeping section extending along the second housing accommodated in the fitting section.

4. The connector according to claim 3,
wherein the front end side of the inclined section has a smaller width in a left-right direction than the rear end side of the inclined section.

5. The connector according to claim 4,
wherein the inclined section is located in the wall surface of the first wall with an interval in the left-right direction,
the creeping section is located between two inclined sections adjacent to each other in the left-right direction, each of which is the inclined section, and
the first wall has, in the wall surface, a second inclined section inclined downward in the left-right direction from the creeping section to the inclined section.

6. The connector according to claim 1,
wherein the second wall extends vertically along an up-down direction serving as a board surface direction of the circuit board, and has a larger dimension in the up-down direction than a dimension in a left-right direction of the first wall.
